(19) United States
(12) Patent Application Publication
(10) Pub. No.: US 2020/0058947 A1
(43) Pub. Date: Feb. 20, 2020

(54) FUEL CELL SYSTEM FOR AN AIRCRAFT

(71) Applicant: Airbus Operations GmbH, Hamburg (DE)

(72) Inventors: Claus HOFFJANN, Hamburg (DE); Christian WOLFF, Hamburg (DE)

(21) Appl. No.: 16/517,269

(22) Filed: Jul. 19, 2019

(30) Foreign Application Priority Data
Aug. 14, 2018 (DE) 102018119758.6

(51) Int. Cl. H01M 8/04089; H01M 8/0438; H01M 8/04746; B64D 31/00

(52) U.S. Cl. CPC H01M 8/04104; H01M 8/04432; H01M 2250/20; B64D 31/00; H01M 8/04783

(57) ABSTRACT

In a fuel cell system intended for a pressure-independent operation, in which at least one fuel cell having an open cathode is provided, a first fluid chamber adjoins an inflow cross section and a second fluid chamber adjoins an outflow cross section. In the fluid chambers can be set an overpressure which is adapted to the operation of the at least one fuel cell.

### CROSS-REFERENCE TO PRIORITY APPLICATION

This application claims the benefit of, and priority to, German patent application number 102018119758.6, filed Aug. 14, 2018. The content of the referenced application is incorporated by reference herein.

### TECHNICAL FIELD

Embodiments of the subject matter described herein relate generally to a fuel cell system for an aircraft and to an aircraft which is equipped with such a fuel cell system.

### BACKGROUND

The use of fuel cells in aircraft is known. There exist various concepts for integrating fuel cells in aircraft. To the use of PEM fuel cells are attached special conditions which relate, in particular, to the observance of specific marginal conditions. Supplied reactants are meant to, as far as possible, not exceed, for instance, a temperature of about 40 to 50° C. Maintenance of a humidity of the membrane should likewise be enabled.

The use of fuel cell stacks having air-cooled, so-called open cathodes is, moreover, very advantageous. However, as a result of the construction, operation at high altitudes is limited to altitudes which lie below about 4000 m. Should such a fuel cell be used in an aircraft, and if it is located in a non-pressurized region of the fuselage, operation is possible only at heights close to the ground.

Patent document DE 10 2005 010 399 A1 shows a fuel cell system for supplying energy to an aircraft, which system comprises a fuel cell, a hydrogen tank and an oxygen tank, wherein the hydrogen tank and the oxygen tank, in order to supply the fuel cell, are connected up to the fuel cell. The fuel cell system is in particular disposed for arrangement in a pressurized and air-conditioned region of the aircraft.

### BRIEF SUMMARY

It is an object of the disclosure to propose a fuel cell system in which the advantages of an open cathode can be exploited, yet integration in a non-pressurized region is enabled and operation at all flight altitudes is possible.

This object is achieved by a fuel cell system having the features of independent Claim 1. Advantageous embodiments and refinements can be derived from the sub-claims and the following description.

A fuel cell system for an aircraft is proposed, comprising a fuel cell unit having an anode inlet and an open cathode, which has an inflow cross section and an outflow cross section, a first fluid chamber having a first cavity, a first connecting opening and at least one first fluid port, a second fluid chamber having a second cavity, a second connecting opening and at least one second fluid port, a device, coupled to the first fluid port, for providing pressurized air, an air outlet coupled to the second fluid port, and a first pressure regulating device, wherein the first connecting opening is connected to the inflow cross section, so that the inflow cross section is in direct connection solely with the first cavity, wherein the second connecting opening is connected to the outflow cross section, so that the outflow cross section is in direct connection solely with the second cavity, and wherein the first pressure regulating device is configured to, by influencing the discharge of air from the second fluid chamber, regulate an overpressure in the second cavity, so that a predetermined airflow necessary for the operation of the fuel cell unit flows from the first fluid chamber, through the open cathode of the fuel cell unit, to the second fluid chamber.

The fuel cell unit is a preferably self-contained sub-assembly, which can contain one or more fuel cells. A fuel cell unit could be constructed, for instance, in the form of a fuel cell stack in which a plurality of fuel cells are arranged and are jointly supplied with reactants. The fuel cell unit possesses, for instance, the anode inlet, through which fuel, preferably hydrogen, can be fed to the fuel cell unit from an external source. It would further be possible to use also a plurality of fuel cell stacks.

According to the disclosure, the fuel cell unit has an open cathode, which possesses an inflow cross section and an outflow cross section. As a result, air can be conducted by simple means to the cathode. The air flows through the inflow cross section into the open cathode, through the open cathode in the direction of the outflow cross section, and there out again. As a result, on the one hand the oxygen which is found in the air is fed as an oxidant to the cathode. On the other hand, heat present in the cathode is absorbed by the air stream and at least partially led away from the cathode. The open cathode consequently facilitates the oxygen supply and the cooling. In addition, water accrued by the continuous air stream can be carried out of the cathode.

A particularity of the fuel cell system according to the disclosure lies in the first fluid chamber, which has a first cavity, a first connecting opening and at least one first fluid port. The first fluid chamber should be regarded as a type of container, the volume of which is defined by the first cavity. The cavity is opened to the outside by the first connecting opening. The first connecting opening can extend over a substantial surface area of a boundary surface of the first fluid chamber. This can also be achieved by the fundamental lack of the relevant boundary surface. The first connecting opening can be adapted to the inflow cross section of the fuel cell unit, so that the first connecting opening can be flushly connected to the inflow cross section of the fuel cell unit.

Preferably, the first fluid chamber is constructed such that it can be flushly attached to the fuel cell unit, so that the inflow cross section and the first connecting opening can be connected to one another in a fluid-tight manner. As a result of this connection, air exiting from the first connecting opening can make its way solely into the inflow cross section. A transition between the first fluid chamber and the fuel cell unit is preferably sealed in order to prevent an escape of air from the connection point.

With the aid of the first fluid port, a fluid connection between the first fluid chamber and the device for providing pressurized air can be realized. In the first cavity of the first fluid chamber an overpressure can thereby be generated, which overpressure leads air to flow into the inflow cross section, through the open cathode and to the second fluid chamber.

The second fluid chamber is designed analogously thereto and consequently has a second cavity, a second connecting opening and at least one second fluid port. The second connecting opening is adapted to be connected to the outflow cross section, so that the open cathode, at its discharge end, is in fluid connection solely with the second cavity. A transition between the outflow cross section and the second fluid chamber can preferably be sealed, so that, there too, the escape of air can be prevented.

The first fluid chamber and the second fluid chamber could respectively be constructed as a separate housing. However, it is also possible to use a single housing, in which both fluid chambers are separated from one another. This housing can also enclose the fuel cell unit. In each version, care should particularly be taken to ensure that the fluid chamber is sealed off from the respectively other fluid chamber and from the fuel cell unit and that solely the aforementioned air stream is realized.

Air which flows from the first fluid chamber into the second fluid chamber leaves the second fluid chamber partially via a second fluid port. This air is somewhat reduced in its oxygen content and slightly warmed by the flow path through the open cathode.

By the first pressure regulating device, the discharge of air from the second fluid chamber is influenced. Through the continuous introduction of pressurized air into the first cavity of the first fluid chamber, the overpressure can consequently be regulated both in the second fluid chamber and in the first fluid chamber directly by the discharge of the air. The hereby resulting pressure level at which the fuel cell unit is found can consequently be adapted in order to ensure an optimal operation of the fuel cell unit. The fuel cell unit thereby becomes independent of its direct environment and could in particular be operated such that it substantially experiences a pressure level like in a ground operation.

In summary, the previously represented structure produces a fuel cell system which can be operated irrespective of varying environmental conditions in an aircraft. This allows both the arrangement in a non-pressurized region of the aircraft and the use of fuel cells having an open cathode. As a result, the structure of the fuel cells and their operation can be significantly simplified and the resulting weight of the fuel cell system is low.

Preferably, the first pressure regulating device is arranged to alter the overpressure in the second cavity in dependence on an ambient pressure of the fuel cell system. The overpressure can there be regulated, for instance, to a predetermined level which enables the normal operation of the fuel cell unit, yet does not necessarily correspond to a pressure on the ground. With falling ambient pressure, the pressure in the second fluid chamber could be lowered, for example, down to a minimum value, so that the mechanical load for the fuel cell system, due to an overpressure, is as low as possible. It is conceivable to set an absolute pressure of at least 600 mbar in the second fluid chamber. It is also conceivable to provide a pressure of at least 100 mbar above the ambient pressure.

Preferably, the fuel cell system further comprises a second pressure regulating device, wherein the anode inlet is coupled to a device for providing hydrogen, wherein the second pressure regulating device is in operative connection with the anode inlet and the device for providing hydrogen, and wherein the second pressure regulating device is arranged to influence a fuel pressure at the anode inlet in dependence on a pressure in the first fluid chamber. The pressure in the first fluid chamber rises when the discharge from the second fluid chamber, in order to increase the pressure there, is influenced and, in particular, throttled. In order to promote a normal operation of the fuel cell system, a suitable fuel pressure should be present at the anode. This should, if possible, approximately correspond to the pressure in the first fluid chamber. Consequently, the second pressure regulating device can be used to achieve this fuel pressure. Through the said operative connection, a pressure control valve, a throttle, or an element for increasing a pressure could, for instance, be directly influenced. In particular, the operative connection can be realized by a valve which is actuated via the pressure in the first fluid chamber. An excessive pressure difference across the fuel cell unit, i.e. between an anode side and a cathode side, is avoided, so that, in particular, a membrane of the fuel cells is not too heavily loaded, or the membranes are not too heavily loaded. It might be preferred to limit a pressure difference, as far as possible, to 350-400 mbar or less. This is dependent on the construction of the at least one fuel cell.

The device for providing pressurized air can in particular have a compressor, which is coupled to the first fluid inlet. The compressor is preferably operated by a mechanically independent device. This could be, for instance, an electric motor, which is supplied with a voltage that is drawn from an airborne supply system of the aircraft or from the fuel cell unit itself. In the latter case there can be provided in particular a buffer store, which, when the fuel cell unit is started up, ensures that the electric motor is supplied with a voltage before the fuel cell unit delivers sufficient voltage. The (absolute) pressure providable by the compressor can lie, for instance, within a range from 0.7 bar to 1.5 bar. Furthermore, a plurality of compressors could also be connected in parallel or in series. Where a plurality of fuel cell stacks are used in the fuel cell unit, respectively at least one compressor could also be used for each fuel cell stack.

In order to prevent a tolerable temperature of supply air from being exceeded, the fuel cell system can further have a precooler for cooling of pressurized air, which precooler is arranged between the device for providing pressurized air and the first fluid inlet. The precooler can have a heat exchanger, which, by way of example, possesses a ribbed or latticed structure. The heat exchanger is flowed through by the compressed air and can here give off heat insofar as the heat exchanger has a lower temperature. By a heat delivery device thermally connected to the heat exchanger, heat can be delivered to the environment or another component. It is conceivable that cavities of the heat exchanger are flowed through by a cooling liquid which belongs to a cooling circuit. The latter could be equipped with a heat delivery device in the form of a further heat exchanger, for instance a skin-section heat exchanger for integration into an outer skin of the aircraft or a heat exchanger flowed through by outside air. The maximally tolerable temperature could be, for instance, around 40-45° C.

The precooler could in particular conditions also be used for the preheating of compressed air. A minimum temperature of somewhat above 0° C. can hence be ensured.

In an advantageous embodiment, the first fluid chamber has a first recirculation port and the second fluid chamber has a second recirculation port, wherein the first and the second recirculation ports are coupled to one another via a fan, which conveys air out of the second fluid chamber into the first fluid chamber. As a result, on the one hand a certain pressure compensation between the second fluid chamber and the first fluid chamber can be realized. On the other hand, the necessary external air stream for flowing through the open cathode can be reduced. Furthermore, the moisture management too could hereby be optimized, since moist return air is mixed back into the supply air.

Between the fan and the first recirculation port could preferably be arranged a non-return valve. This prevents air from flowing air directly from the first fluid chamber into the second fluid chamber and from herein completely by passing the fuel cell unit. The operation of the fuel cell unit will thereby be ensured upon any recirculation.

The fuel cell system can in an advantageous embodiment further have a third pressure regulating device, which is arranged to, in dependence on an ambient pressure of the fuel cell system, influence a fluid volume flow from the second fluid chamber into the first fluid chamber. It is preferred, for example, with decreasing pressure or rising height, to set a stronger recirculation volume flow. In particular, the pressure regulating device can be arranged to set the volume steplessly. It should, however, in any event be prevented that a 100% recirculation takes place and fully closes the first pressure control valve. In this case, the operation of the fuel cell unit would be interrupted.

The fuel cell system according to the disclosure can further have a flush valve, which is connected to an anode outlet and is arranged to selectively flush the anode. Such a flush valve is also known as a “purge valve” and can deliver water accumulated at or in the anode according to need or at regular or irregular intervals. The flushing should lead to the flushing of, as far as possible, less than 2% of the hydrogen. In addition, it should be prevented that, before, during or after the flushing, anode-side pressure peaks arise, which lie above a tolerable pressure difference between anode and cathode. This pressure difference is dependent on the design of the at least one fuel cell and could amount to, for instance, 350-400 mbar.

The fuel cell system can further comprise a fuel pressure control valve, which is coupled to the anode inlet and is arranged to influence a through-flow of fuel into the anode inlet. A type of pre-regulation is thereby performed. Particularly in the use of fuel cells which consume pure hydrogen, a relatively high pressure can be present at a device for the delivery of hydrogen. By the fuel pressure control valve, the fuel pressure is throttled and lies significantly below the original pressure. Significantly lower requirements can then be placed on the second pressure control valve, if this is used. Preferably, the fuel pressure¬control valve is a fixedly set or non-adjustable pressure control valve.

In a further advantageous embodiment, the device for providing pressurized air and the first pressure regulating device are arranged to set and maintain an operating differential pressure, which is predetermined for the operation of the fuel cell unit, independently of an ambient pressure of the fuel cell system. A desired air volume flow is thereby ensured.

For the pressure control valves, several working principles enter into consideration, which are familiar to a person skilled in the art. In particular, they can be constructed as spring-loaded diaphragm valves. Instead of these, electrically actuated valves, which are coupled to a control unit, could also be used. The control unit can further be coupled to sensors, which measure relevant pressures and prompt the control unit to directly actuate the valves.

The disclosure further relates to an aircraft, comprising a fuselage and at least one fuel cell system having the aforementioned features.

The at least one fuel cell system can be arranged in a non-pressurized region of the aircraft fuselage. As a result of the previously portrayed structure, the fuel cell unit can be operated independently of the ambient pressure of the aircraft. A positioning in a non-pressurized region of the aircraft is therefore readily possible.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Further features, advantages and possible applications of the present disclosure emerge from the following description of the illustrative embodiments and the figures. All described and/or depicted features here form in their own right and in any chosen combination the subject of the disclosure, also independently of their composition in the individual claims or the back-references thereof. In the figures, the same reference symbols continue to stand for the same or similar objects.

FIG. 1a shows a schematic representation of the fuel cell system.

FIGS. 1b and 1c show schematic representations of the two fluid chambers in a side view.

FIG. 2 shows an aircraft in the form of a commercial airplane having a fuel cell system installed therein.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

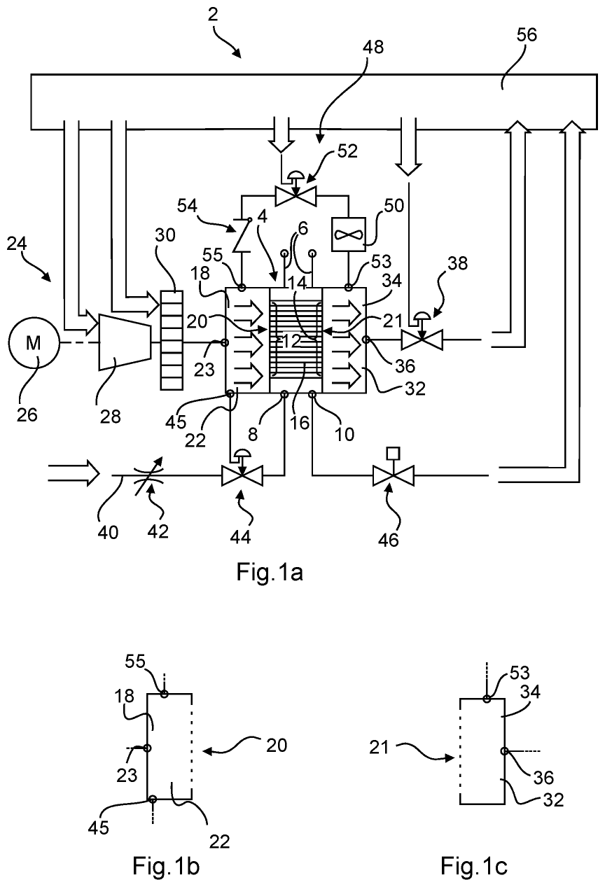

FIG. 1a shows a schematic representation of a fuel cell system 2. This has a fuel cell unit 4, which, by way of example, possesses a plurality of single (not individually represented) fuel cells, which together form a coherent unit, for example in the form of a fuel cell stack. In order to supply consumer appliances with electric voltage, the fuel cell unit 4 is provided with electrical conductors 6, which can be connected, for instance, to an airborne supply system of an aircraft when the fuel cell system 2 is installed in one such thereof. For the supplying of the fuel cell unit 4 with fuel, for example hydrogen, an anode inlet 8 and an anode outlet 10 are provided.

The fuel cell unit 4 has, moreover, an inflow cross section 12 and an outflow cross section 14, which serve to make air flow through an open cathode 16 of the fuel cell unit 4. The inflow cross section 12 is directly adjoined by a first fluid chamber 18, which has a first connecting opening 20 that is connected solely to the inflow cross section 12. A first cavity 22 inside the first fluid chamber 18 is therefore in fluid connection solely with the inflow cross section 12.

In addition, a device 24 for providing pressurized air is provided. This is equipped with a motor 26 and a compressor 28 drivable by the motor 26 and provides pressurized air. This can be warmed by the compression and is, in this illustrative embodiment, conducted through an optional precooler 30, which is represented merely schematically. It is self-evident that the precooler 30 is arranged to cool the compressed air and to transport the heat of the compressed air, for example through a suitable medium, from the precooler 30 to a heat delivery device (not shown).

Through the introduction of the pressurized air via a first fluid port 23, in the first cavity 22 is formed an overpressure, by which air flows via the inflow cross section 12 into the cathode 16. Since the cathode 16 is constructed as an open cathode, the air flows through this and via the outflow cross section 14 into a second fluid chamber 32, i.e. into a second cavity 34 which is present there. The second fluid chamber 32 has a second connecting opening 21, which is in connection solely with the outflow cross section 14. Via a second fluid port 36, the air is delivered to the outside. As a result, the cathode 16 is supplied by the air with oxygen and further cooled.

Downstream of the second fluid port 36 is arranged a first pressure regulating device 38, which, by way of example, in dependence on an ambient pressure, influences the discharge from the second cavity 34. The pressure is thereby influenced both in the second cavity 34 and in the first cavity 22. Through targeted influencing of the discharge, a specific pressure level can be achieved in the second cavity 34 and, as a result of the fluid connection to the first cavity 22, there too.

For the pre-regulation of a fuel pressure, a fuel line 40 is equipped with a fuel pressure control valve 42, which could be constructed as a simple throttle valve. A second pressure regulating device 44 is here arranged, by way of example, downstream of the fuel pressure control valve 42 and can set a pressure of the fuel downstream of the second pressure regulating device 44 in dependence on the pressure in the first cavity 22. To this end, the second pressure regulating device is connected via a pressure port 45 to the first fluid chamber 18. As a result of the pre-regulation of the fuel pressure, the second pressure regulating device 44 has only to conduct a relatively small reduction of the fuel pressure. Further downstream follows the anode inlet 8, into which the fuel is introduced. It is preferred that the pressure of the fuel at the anode inlet 8 substantially corresponds to the pressure in the first cavity 22.

In order to flush the anode of the fuel cell unit 4 and herein, in particular, rid it of accumulated water, a flush valve 46 is present. The actuation can be realized selectively, according to need, or in an automated manner at specific time intervals.

Inter alia for the improved alignment of the pressures in the first cavity 22 and the second cavity 34, a bypass arrangement 48 can be used. This comprises, by way of example, a fan 50, a third pressure regulating device 52 and a non-return valve 54. Air can hereby be drawn from the second cavity 34 via a second recirculation port 53, which at the same time can be one of a plurality of second fluid ports. This air can be conveyed by the fan 50 to a first recirculation port 55. This can be one of a plurality of first fluid ports. Consequently, air is actively drawn by the fan 50 out of the second cavity 34 and fed to the first cavity 22. By the non-return valve 54, it is achieved that air cannot flow directly out of the first fluid chamber 18 into the second fluid chamber 32. The fan 50 shall be designed such that the hereby achievable pressure difference exceeds the drop in pressure between the first fluid chamber 18 and the second fluid chamber 32.

The third pressure regulating device 52 is arranged to, independently of an ambient pressure of the fuel cell system 2, influence a fluid volume flow from the second fluid chamber 32 into the first fluid chamber 18. In particular, the third pressure regulating device 52 opens when the ambient pressure becomes lower and closes when the ambient pressure becomes higher.

Merely by way of example, the environment with the ambient pressure and with the air contained in the environment is represented as a block, which has the reference symbol 56. Air from the environment 56 is fed to the compressor 28, the precooler 30 and the first pressure regulating device 38, and in the form of a pressure, to the third pressure regulating device 52.

FIGS. 1b and 1c additionally show schematically the two fluid chambers 18 and 32, in which respectively the connecting opening 20 or 21 is indicated. This latter is adapted to the inflow cross section 12 and outflow cross section 14 respectively. The two fluid chambers 18 and 32 are configured such that they are attachable, preferably flushly, to the fuel cell unit 4. The connecting openings 20 and 21 should here be brought into connection solely with the respective cross section 12 or 14. Transitions or separation points between the fuel cell unit 4 and outer boundaries of the fluid chambers 18 and 32 are here sealed.

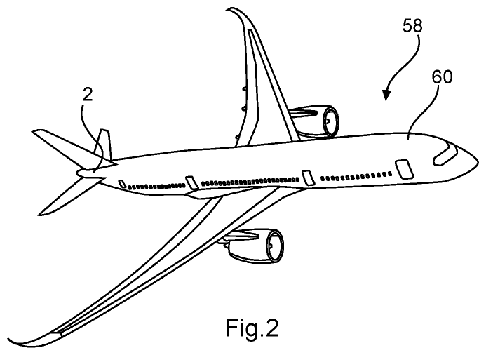

FIG. 2 shows an aircraft 58, which has a fuselage 60 and a fuel cell system 2 installed therein. The fuel cell system 2 is arranged, by way of example, in a rear part of the fuselage 60 and is preferably located in a non-pressurized region.

In addition, it should be pointed out that “comprising” does not preclude any other elements or steps, and “a” or “one” does not preclude a plurality. It should further be pointed out that features which have been described with reference to one of the above illustrative embodiments can also be used in combination with other features of other above-described illustrative embodiments. Reference symbols in the claims should not be regarded as a restriction.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A fuel cell system for an aircraft, comprising:
a fuel cell unit having an anode inlet and an open cathode, which has an inflow cross section and an outflow cross section;
a first fluid chamber having a first cavity, a first connecting opening and at least one first fluid port;
a second fluid chamber having a second cavity, a second connecting opening and at least one second fluid port;
a device coupled to the first fluid port to provide pressurized air;
an air outlet coupled to the second fluid port; and
a first pressure regulating device;
wherein the first connecting opening is connected to the inflow cross section such that the inflow cross section is in direct connection solely with the first cavity;
wherein the second connecting opening is connected to the outflow cross section such that the outflow cross section is in direct connection solely with the second cavity;
wherein the first pressure regulating device is configured to, by influencing the discharge of air from the second fluid chamber, regulate an overpressure in the second cavity, so that a predetermined airflow necessary for the operation of the fuel cell unit flows from the first fluid chamber, through the open cathode of the fuel cell unit, to the second fluid chamber.

2. The fuel cell system according to claim 1, wherein the first pressure regulating device is arranged to alter the overpressure in the second cavity in dependence on an ambient pressure of the fuel cell system.

3. The fuel cell system according to claim 1, further comprising a second pressure regulating device, wherein:
the anode inlet is coupled to a device for providing hydrogen;
the second pressure regulating device is in operative connection with the anode inlet and the device for providing hydrogen; and
the second pressure regulating device is arranged to influence a fuel pressure at the anode inlet in dependence on a pressure in the first fluid chamber.

4. The fuel cell system according to claim 1, wherein the device for providing pressurized air has a compressor coupled to the first fluid inlet.

5. The fuel cell system according to claim 1, wherein a precooler for cooling pressurized air is arranged between the device for providing pressurized air and the first fluid inlet.

6. The fuel cell system according to claim 1, wherein:
the first fluid chamber has a first recirculation port;
the second fluid chamber has a second recirculation port; and
the first recirculation port and the second recirculation port are coupled to one another via a fan, which conveys air out of the second fluid chamber into the first fluid chamber.

7. The fuel cell system according to claim 6, further comprising a non-return valve between the fan and the first recirculation port.

8. The fuel cell system according to claim 6, further comprising a third pressure regulating device arranged to, in dependence on an ambient pressure of the fuel cell system, influence a fluid volume flow from the second fluid chamber into the first fluid chamber.

9. The fuel cell system according to claim 1, further comprising a flush valve connected to an anode outlet and arranged to selectively flush the anode of the fuel cell unit.

10. The fuel cell system according to claim 1, further comprising a fuel pressure control valve coupled to the anode inlet and arranged to influence a through-flow of fuel into the anode inlet.

11. The fuel cell system according to claim 1, wherein the device for providing pressurized air and the first pressure regulating device are arranged to set and maintain an operating differential pressure, which is predetermined for the operation of the fuel cell unit, independently of an ambient pressure of the fuel cell system.

12. An aircraft comprising:
an aircraft fuselage; and
at least one fuel cell system according to claim 1.

13. The aircraft according to claim 12, wherein the at least one fuel cell system is arranged in a non-pressurized region of the aircraft fuselage.
